(19) United States
(12) Patent Application Publication
(10) Pub. No.: US 2013/0035100 A1
(43) Pub. Date: Feb. 7, 2013

(54) RADIO BASE STATION AND COMMUNICATION CONTROL METHOD

(71) Applicant: Keiji Murakami, Kanagawa (JP)

(72) Inventor: Keiji Murakami, Kanagawa (JP)

(73) Assignee: KYOCERA CORPORATION, Kyoto (JP)

(21) Appl. No.: 13/641,040

(22) PCT Filed: Apr. 14, 2011
(86) PCT No.: PCT/JP2011/059313

§ 371 Date: Oct. 12, 2012

(30) Foreign Application Priority Data
Apr. 14, 2010 (JP) 2010-093421

(51) Int. Cl. H04W 36/20; H04W 4/00

(52) U.S. Cl. 455/436; 455/422.1

(57) ABSTRACT

An LTE base station (10-1), when an X2 interface to another LTE base station is working, uses the X2 interface to transmit an ICIC-related message to the other LTE base station. When the X2 interface to the other LTE base station is not working, the LTE base station (10-1) uses an S1 interface to transmit an ICIC-related message to the other LTE base station.

### TECHNICAL FIELD

The present invention relates to a radio base station configuring a radio communication system in which a first interface that is a logical transmission path between a radio base station and a network control device in an upper network, and a second interface that is a logical transmission path between radio base stations can be established, and also relates to a communication control method in the radio base station.

### BACKGROUND ART

In 3GPP (Third Generation Partnership Project), in a radio communication system corresponding to LTE (Long Term Evolution) for which standards are being formulated currently, in order to reduce the interference between radio base stations (hereinafter, called “LTE base stations”), an Inter-Cell Interference Coordination (ICIC) function is provided (for example, see NPL 1). According to ICIC, an LI (Load Information) message is exchanged between the LTE base stations periodically. The LI message is information concerning an interference (interference information), and includes an OI (Overload Indicator), an HII (High Interference Indicator), and an RNTPI (Relative Narrowband Tx Power Indicator).

### CITATION LIST

### Non-Patent Document

[Non-Patent Literature 1] “3GPP TS 36.300 V8.5.0 (May 2008)”, [online], [searched on Mar. 25, 2010], <URL: http://www.arib.or.jp/IMT-2000/V700Sep08/5_Appendix/Re18/36/36300-850.pdf>

### SUMMARY OF THE INVENTION

However, according to the aforementioned ICIC, an LI message exchanged between LTE base stations is stipulated as a message (an X2 message) that is exchanged only by using an X2 interface. Therefore, an LI message is not exchanged between LTE base stations where the X2 interface is not utilized. As a result, in some cases, an LTE base station is not able to recognize the interference in the other LTE base station, and therefore, cannot perform the process for reducing the interference.

In view of the aforementioned problem, an object of the present invention is to provide a radio base station and a communication control method, with which it is possible to appropriately reduce the interference between radio base stations.

To solve the above problem, the present invention has following features. A first feature of the present invention is summarized as a radio base station configuring a radio communication system in which a first interface that is a logical transmission path between a radio base station and a network control device in an upper network, and a second interface that is a logical transmission path between radio base stations can be established, comprising: a transmission unit (ICIC-related message transmission processing unit 154) configured to transmit interference information concerning interference, to a first radio base station in which the second interface is not utilized between the radio base station, by using the first interface.

Such a radio base station transmits the interference information, to the other radio base station in which the second interface is not utilized between the radio base station, by using the first interface. Therefore, unlike in the past, it is possible to avoid a situation where the interference information is not transmitted, to the other radio base station in which the second interface is not utilized between the radio base station, resulting in an appropriate reduction of the interference between the radio base stations.

A second feature of the present invention is summarized as that the transmission unit transmits the interference information to the first radio base station by using the first interface, when the connection destination of the radio terminal switches from the first radio base station to the radio base station as a result of the transmission and reception of the control information via the first interface.

A third feature of the present invention is summarized as that the transmission unit transmits the interference information, to a second radio base station in which the second interface is utilized between the radio base station, by using the second interface, and thereafter the transmission unit transmits the interference information to the first radio base station, by using the first interface.

A fourth feature of the present invention is summarized as that the transmission unit transmits the interference information, to a second radio base station in which the second interface is utilized between the radio base station, by using the second interface, and thereafter the transmission unit transmits the interference information to the other first radio base station, by using the first interface, if the interference is not reduced.

A fourth feature of the present invention is summarized as a communication control method in a radio base station configuring a radio communication system in which a first interface that is a logical transmission path between a radio base station and a network control device in an upper network, and a second interface that is a logical transmission path between radio base stations can be established, comprising: a step of transmitting interference information concerning interference, to a first radio base station in which the second interface is not utilized between the radio base station, by using the first interface.

According to the present invention, it is possible to appropriately reduce the interference between radio base stations

### BRIEF DESCRIPTION OF THE DRAWINGS

FIG. 1 is a diagram showing the entire schematic configuration of a radio communication system according to an embodiment of the present invention.

FIG. 2 is a diagram showing a state where an S1 interface is established in the radio communication system according to the embodiment of the present invention.

FIG. 3 is a diagram showing a state where an X2 interface is established in the radio communication system according to the embodiment of the present invention.

FIG. 4 is a configuration diagram of an LTE base station according to the embodiment of the present invention.

FIG. 5 is a configuration diagram of an MME/SGW according to the embodiment of the present invention.

FIG. 6 is a sequence diagram showing an operation during an S1 handover in the radio communication system according to the embodiment of the present invention.

FIG. 7 is a flowchart showing an operation of identifying an S1 handover-source base station in an LTE base station according to the embodiment of the present invention.

FIG. 8 is a sequence diagram showing an operation of transmitting and receiving an ICIC-related message in the radio communication system according to the embodiment of the present invention.

FIG. 9 is a flowchart showing a first operation during the transmission of an ICIC-related message in an LTE base station according to the embodiment of the present invention.

FIG. 10 is a flowchart showing a second operation during the transmission of an ICIC-related message in an LTE base station according to the embodiment of the present invention.

### MODES FOR CARRYING OUT THE INVENTION

Next, an embodiment of the present invention will be described with reference to the drawings. Specifically, (1) Schematic configuration of radio communication system, (2) Configuration of LTE base station, (3) Configuration of MME/SGW, (4) Operation of radio communication system, (5) Operation and effect, and (6) Other embodiments will be described. It is to be noted that the same or similar reference numerals are applied to the same or similar parts through the drawings in the following embodiments.

### (1) Schematic Configuration of Radio Communication System

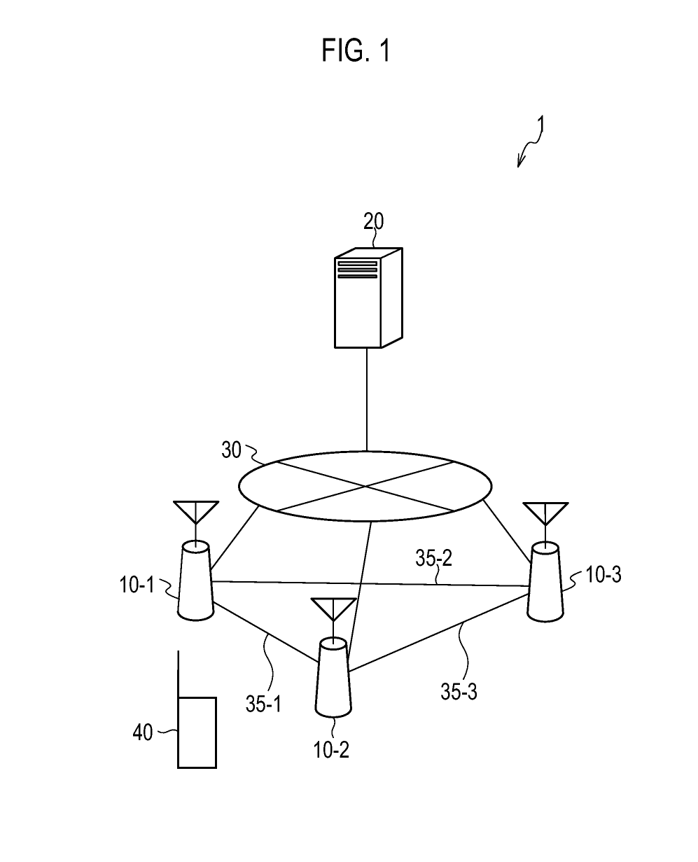

FIG. 1 is a diagram showing the schematic configuration of a radio communication system according to the present embodiment. In the present embodiment, a radio communication system 1 is configured by using an LTE technology. The radio communication system 1 illustrated in FIG. 1 includes LTE base stations 10-1, 10-2, and 10-3, which are radio base stations, an MME (Mobile Management Entity)/SGW (Serving Gateway) 20, which is a network control device, a core network 30 configured to connect the LTE base stations 10-1 through 10-3 with the MME/SGW 20, an optical fiber 35-1 configured to connect the LTE base station 10-1 with the LTE base station 10-2, an optical fiber 35-2 configured to connect the LTE base station 10-1 with the LTE base station 10-3, an optical fiber 35-3 configured to connect the LTE base station 10-2 with the LTE base station 10-3, and a radio terminal 40.

The LTE base stations 10-1 through 10-3 perform radio communication with the radio terminal 40 via a radio communication zone. In LTE, a communication scheme between the LTE base stations 10-1 through 10-3 and the radio terminal 40 is called E-UTRAN (Evolved UMTS Terrestrial Radio Access Network).

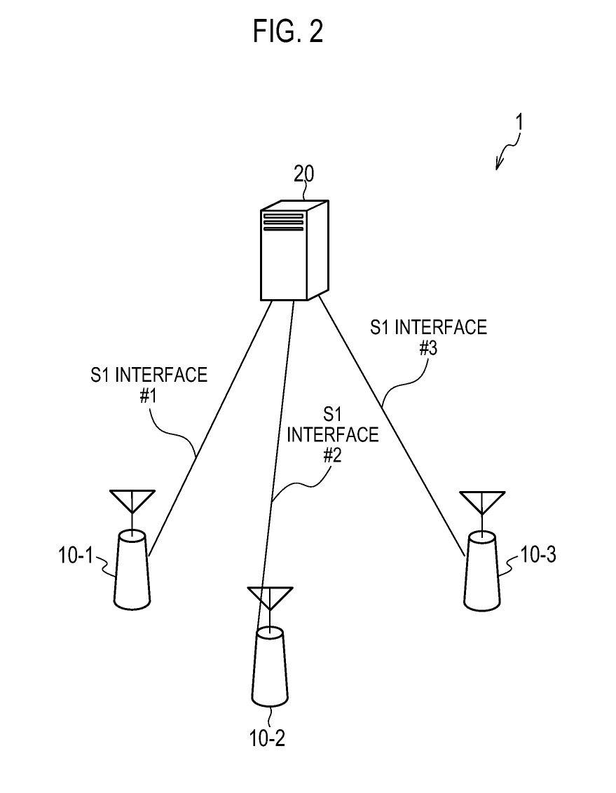

FIG. 2 is a diagram showing a state where an S1 interface is established in the radio communication system 1. In FIG. 2, an S1 interface #1, which is a logical transmission path of the transport layer, is established between the LTE base station 10-1 and the MME/SGW 20, via the core network 30. Furthermore, an S1 interface #2 is established between the LTE base station 10-2 and the MME/SGW 20, via the core network 30. An S1 interface #3 is established between the LTE base station 10-3 and the MME/SGW 20, via the core network 30.

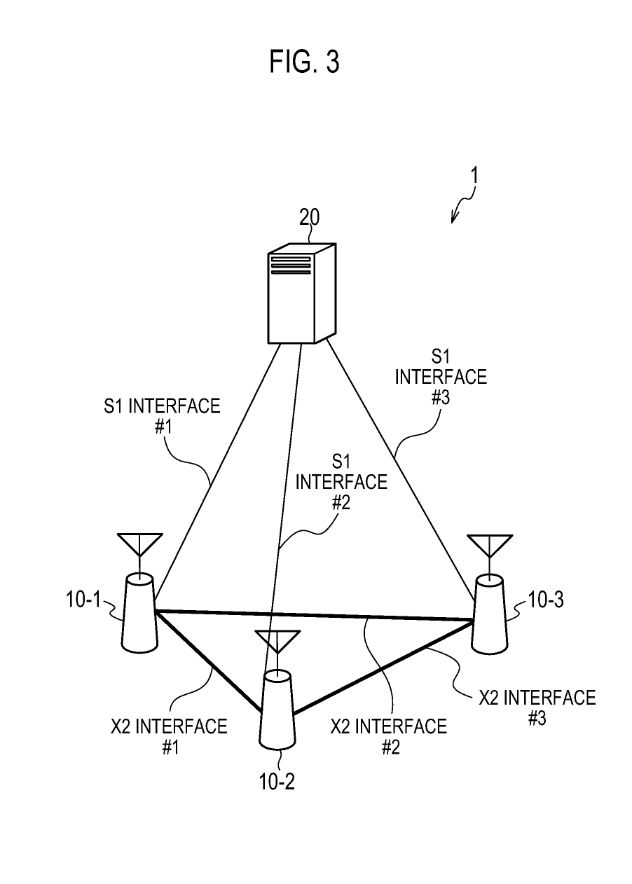

FIG. 3 is a diagram showing a state where an X2 interface is established in the radio communication system 1. In FIG. 3, an X2 interface #1, which is a logical transmission path of the transport layer, can be established between the LTE base station 10-1 and the LTE base station 10-2, via the optical fiber 35-1. Furthermore, an X2 interface #2 can be established between the LTE base station 10-1 and the LTE base station 10-3, via the optical fiber 35-2. An X2 interface #3 can be established between the LTE base station 10-2 and the LTE base station 10-3, via the optical fiber 35-3. However, while the establishment of the S1 interface is mandatory, the establishment of the X2 interface is optional.

In the radio communication system 1 employing LTE, a handover in which data forwarding is executed by using the X2 interface (hereinafter, called the “X2 handover”), and a handover in which data forwarding is executed by using the S1 interface (hereinafter, called the “S1 handover”) are stipulated. Data forwarding is a function by which immediately before a handover, the handover-source LTE base station forwards the data that could not be transmitted to a radio terminal, to the handover-destination LTE base station, by using the X2 interface and the S1 interface.

When an X2 interface has been established between LTE base stations, the handover that is performed by considering one of the LTE base stations as the handover source (Source eNB) and the other as the handover destination (Target eNB) is the X2 handover. Furthermore, when an X2 interface has not been established between LTE base stations, the handover that is performed by considering one of the LTE base stations as the handover source and the other as the handover destination is the S1 handover. That is, between the X2 handover and the S1 handover, the X2 handover is given priority for reducing the transmission delay time during data forwarding between LTE base stations.

### (2) Configuration of LTE Base Station

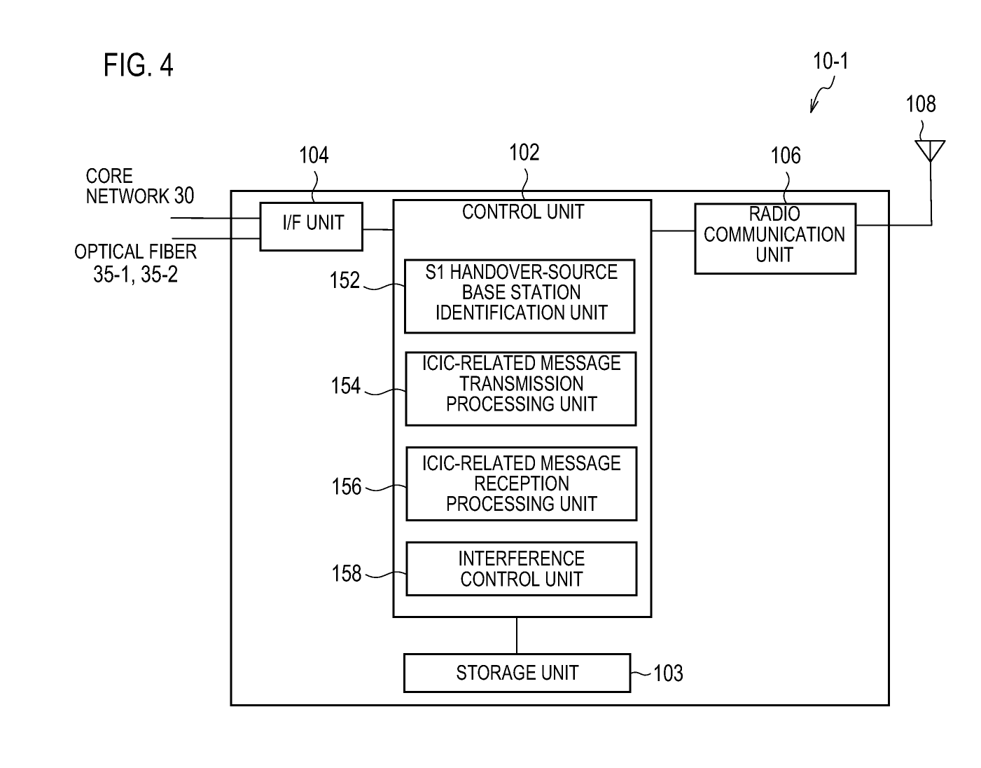

FIG. 4 is a diagram showing the configuration of the LTE base station 10-1. The LTE base station 10-1 shown in FIG. 2 includes a control unit 102, a storage unit 103, an I/F unit 104, a radio communication unit 106, and an antenna 108. In addition, the LTE base stations 10-2 and 10-3 also have the same configuration as that of the LTE base station 10-1.

The control unit 102, for example, is configured by using a CPU (Central Processing Unit) and a DSP (Digital Signal Processor), and controls various functions of the LTE base station 10-1. The storage unit 103, for example, is configured by a memory, and stores various types of information used in control and the like in the LTE base station 10-1.

The I/F unit 104 is connected to the core network 30, the optical fiber 35-1, and the optical fiber 35-2. The radio communication unit 106 includes an RF circuit, a baseband circuit and the like, performs modulation, demodulation, encoding, decoding and the like, and transmits and receives a radio signal to/from the radio terminal 40 through the antenna 108.

The control unit 102 includes an S1 handover-source base station identification unit 152, an ICIC-related message transmission processing unit 154, an ICIC-related message reception processing unit 156, and an interference control unit 158.

When an S1 handover is performed with the other LTE base station (here, the LTE base station 10-2 or the LTE base station 10-3, other than the LTE base station 10-1) as the handover source, and the LTE base station 10-1 as the handover destination, the S1 handover-source base station identification unit 152 identifies the other LTE base station that is the handover source.

When the information necessary for a handover cannot be transmitted by using the X2 interface, in other words, when an X2 handover cannot be performed because the X2 interface is not utilized between the handover-source LTE base station and the handover-destination LTE base station, the S1 handover is performed in place of the X2 handover. The case when the X2 interface is not utilized indicates either a case when the X2 interface is not established, or a case when the X2 interface might be established but information cannot be transmitted by using the X2 interface due to some failure.

Regardless of the fact that the other LTE base station that is the handover source of the S1 handover exists close to the LTE base station 10-1 so as to perform a handover with the LTE base station 10-1, as the X2 interface is not utilized, the other LTE base station can be regarded as an LTE base station that cannot transmit an ICIC-related message with the LTE base station 10-1 by using the X2 interface.

When an S1 handover is performed, the S1 handover-source base station identification unit 152 acquires the global ID (Global-CID), which is the identification information of the other handover-source LTE base station, included in the handover information (for example, the handover request) from the other handover-source LTE base station. The S1 handover-source base station identification unit 152 stores the acquired global ID in the storage unit 103 as the global ID (S1 interface global ID) of the other handover-source base station when an S1 handover is performed with the LTE base station 10-1 as the handover destination.

The ICIC-related message transmission processing unit 154 is configured to perform the process of transmitting an ICIC-related message to the other LTE base station, via the I/F unit 104. The ICIC-related message is an LI (Load Information) message including the information concerning the interference occurring in the LTE base station 10-1 (interference information). The LI message is information concerning an interference (interference information), and includes an OI (Overload Indicator), an HII (High Interference Indicator), and an RNTPI (Relative Narrowband Tx Power Indicator).

The OI is a message used when a resource block that receives an interference of a value equal to or above the threshold value is notified from the LTE base station 10-1 to the other LTE base station, during uplink communication from the radio terminal 40 to the LTE base station 10-1. The HII is a message used when the LTE base station 10-1 notifies a resource block that is expected to be used in the uplink direction to the other LTE base station, and restricts the use in the other LTE base station. The RNTPI is a message used when the transmission power is reduced in the other LTE base station with regard to a predetermined resource block in the downlink communication from the LTE base station 10-1 to the radio terminal 40.

The OI is a message that is used when the LTE base station 10-1 actually receives an interference. The ICIC using an OI is called a reactive scheme. On the other hand, the HII and the RNTPI are messages used to prevent an interference before the LTE base station 10-1 receives the interference. The ICIC using an HII and an RNTPI is called a proactive scheme.

The ICIC-related message transmission processing unit 154 determines whether or not the transmission condition of an ICIC-related message is fulfilled.

Specifically, when an ICIC is a reactive scheme, the LTE base station 10-1 determines whether or not a resource block that receives an interference of a value equal to or above the threshold value exists in the uplink communication. When a resource block that receives an interference of a value equal to or above the threshold value exists in the uplink communication, the LTE base station 10-1 determines that the transmission condition of an ICIC-related message is fulfilled.

Furthermore, when an ICIC is a proactive scheme, the LTE base station 10-1 determines whether or not the resource block that is expected to be used exists. When the resource block that is expected to be used exists, the LTE base station 10-1 determines that the transmission condition of an ICIC-related message is fulfilled.

When the transmission condition of an ICIC-related message is fulfilled, the ICIC-related message transmission processing unit 154 identifies the other LTE base station in which the X2 interface with the LTE base station 10-1 is utilized. For example, the storage unit 103 stores the global ID (X2 interface global ID) of the other LTE base station in which the X2 interface with the LTE base station 10-1 is utilized. Depending on the X2 interface global ID read from the storage unit 103, the ICIC-related message transmission processing unit 154 can identify the other LTE base station in which the X2 interface with the LTE base station 10-1 is utilized.

For example, the LTE base station 10-1 transmits a predetermined signal (for example, a ping) to the other LTE base station by using the X2 interface, in a predetermined period. When the X2 interface is utilized, the other LTE base station transmits a response signal to the predetermined signal from the LTE base station 10-1 to the LTE base station 10-1 by using the X2 interface. When the LTE base station 10-1 receives the response signal, the other LTE base station that is the transmission source of the response signal is identified as the other LTE base station in which the X2 interface with the LTE base station 10-1 is utilized.

By considering the X2 interface global ID read from the storage unit 103 as the destination, the ICIC-related message transmission processing unit 154 transmits an ICIC-related message by using the X2 interface.

Alternatively, the ICIC-related message transmission processing unit 154 transmits the ICIC-related message via broadcast communication, by using the X2 interface.

When the ICIC is a reactive scheme, the ICIC-related message transmission processing unit 154 transmits an OI as the ICIC-related message. Furthermore, when the ICIC is a proactive scheme, the ICIC-related message transmission processing unit 154 transmits an HII and an RNTPI as the ICIC-related message.

Following this, the ICIC-related message transmission processing unit 154 determines whether or not the value of the interference occurring in the LTE base station 10-1 is equal to or below a predetermined value. When the ICIC is a reactive scheme, the other LTE base station that is the transmission destination of the ICIC-related message is the source of occurrence of the interference, and by controlling the interference in the other LTE base station, the interference occurring in the LTE base station 10-1 is reduced. Furthermore, when the ICIC is a reactive scheme, the other LTE base station that is the transmission destination of the ICIC-related message is the source of occurrence of the interference, and by controlling the interference in the other LTE base station, the interference occurring in the LTE base station 10-1 may be reduced or be kept at a low level.

Therefore, when the value of the interference occurring in the LTE base station 10-1 exceeds the predetermined value, it can be regarded that the other LTE base station that is the transmission destination of the ICIC-related message transmitted by the LTE base station 10-1 by using the X2 interface is not a source from which the interference occurs.

As a result, when the value of the interference occurring in the LTE base station 10-1 exceeds the predetermined value, the ICIC-related message transmission processing unit 154 performs the process of transmitting the ICIC-related message to the other LTE base station, by using the SI interface.

Specifically, the ICIC-related message transmission processing unit 154 reads an S1 interface global ID stored in the storage unit 103. Additionally, by considering the read S1 interface global ID as the destination, the ICIC-related message transmission processing unit 154 transmits the ICIC-related message via unicast communication or multicast communication using the S1 interface.

The ICIC-related message reception processing unit 156 receives an ICIC-related message from the other LTE base station by using the X2 interface or the S1 interface.

When an ICIC-related message is received from the other LTE base station, the interference control unit 158 performs control to reduce the interference in the other LTE base station, based on the ICIC-related message.

Specifically, when the ICIC-related message is an OI, the interference control unit 158 either reduces the transmission power corresponding to the resource block indicated by the OI, or does not use the resource block indicated by the OI. When the ICIC-related message is an HII, the interference control unit 158 does not use the resource block indicated by the HII, as far as possible. When the ICIC-related message is an RNTPI, the interference control unit 158 reduces the transmission power corresponding to the resource block indicated by the RNTPI.

### (3) Configuration of MME/SGW

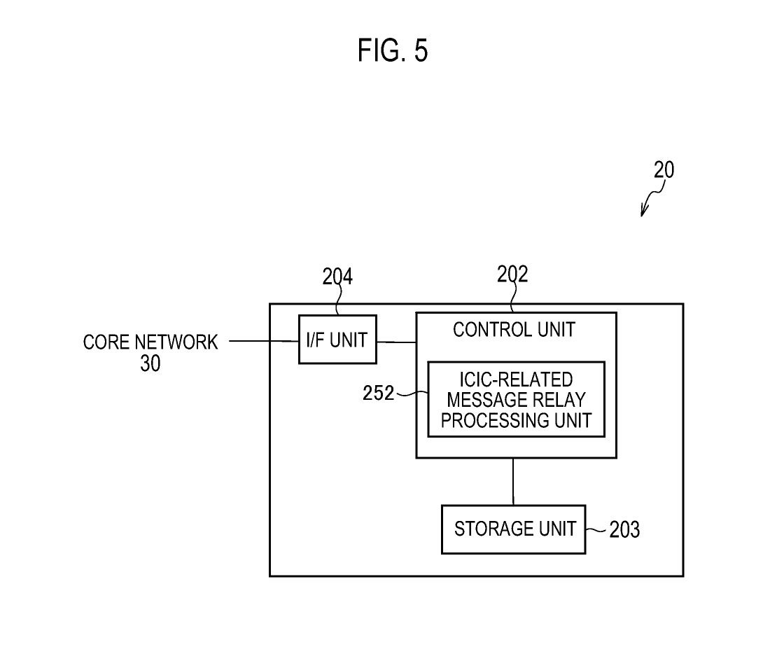

FIG. 5 is a diagram showing the configuration of the MME/SGW 20. The MME/SGW 20 shown in FIG. 5 includes a control unit 202, a storage unit 203, and an I/F unit 204.

The control unit 202, for example, is configured by a CPU and a DSP, and controls the various functions of the MME/SGW 20. The storage unit 203, for example, is configured by a memory, and stores various types of information used in control and the like in the MME/SGW 20. The I/F unit 204 is connected to the core network 30.

The control unit 202 includes an ICIC-related message relay processing unit 252. The ICIC-related message relay processing unit 252 is configured to receive an ICIC-related message from the LTE base stations 10-1 through 10-3, via the S1 interface and the I/F unit 204 in the core network 30. Based on the destination information in the received ICIC-related message, the ICIC-related message relay processing unit 252 identifies any one of the LTE base stations 10-1 through 10-3 as the destination of the ICIC-related message. Moreover, the ICIC-related message relay processing unit 252 transmits the ICIC-related message to any one of the identified LTE base stations 10-1 through 10-3, via the X2 interface in the core network 30 established between the I/F unit 204 and any one of the identified LTE base stations 10-1 through 10-3.

### (4) Operation of Radio Communication System

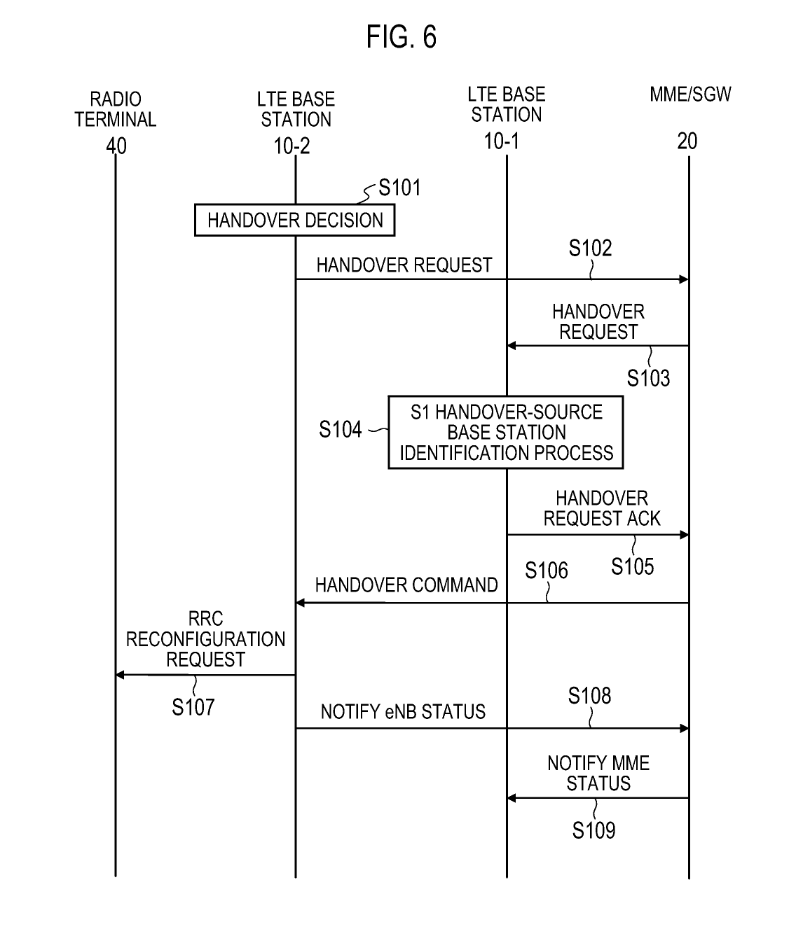

FIG. 6 is a sequence diagram showing an operation during an S1 handover in the radio communication system 1. FIG. 6 is an example of a case in which an S1 handover is performed for the radio terminal 40, with the LTE base station 10-2 as the handover source and the LTE base station 10-1 as the handover destination.

In step S101, the LTE base station 10-2 that is the handover source to which the radio terminal 40 is connected decides to perform a handover to switch the connection destination of the radio terminal 40 from the LTE base station 10-2 to the LTE base station 10-1. In step S102, the LTE base station 10-2 transmits a handover request to the MME/SGW 20 by using the S1 interface. The MME/SGW 20 receives the handover request.

In step S103, the MME/SGW 20 transmits the received handover request to the LTE base station 10-1 by using the S1 interface. The LTE base station 10-1 receives the handover request.

In step S104, the LTE base station 10-1 performs the process of identifying the other LTE base station (here, the LTE base station 10-2) that is the handover source in an S1 handover. Specifically, the following process is performed.

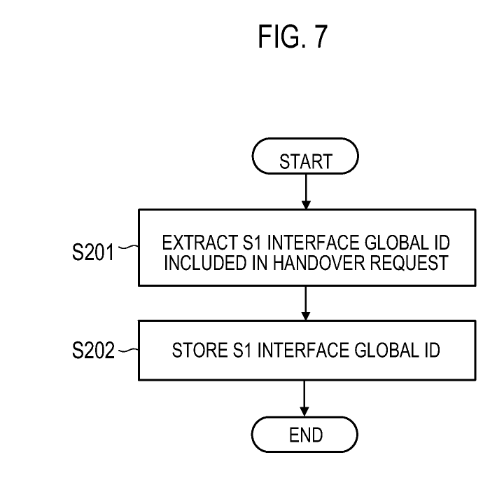

FIG. 7 is a flowchart showing an operation of identifying the other LTE base station that is the S1 handover source in the LTE base station 10-1.

In step S201, the LTE base station 10-1 extracts the S1 interface global ID included in the handover request. In step S202, the LTE base station 10-1 stores the S1 interface global ID.

Returning to FIG. 6, the explanation continues. In step S105, when a handover request is received, the LTE base station 10-1 transmits an ACK (handover request ACK) for the handover request to the MME/SGW 20, by using the S1 interface. The MME/SGW 20 receives the handover request ACK.

In step S106, the MME/SGW 20 transmits a handover command to the LTE base station 10-2 by using the S1 interface. The LTE base station 10-2 receives the handover command.

In step S107, the LTE base station 10-2 transmits an RRC (Radio Resource Control) reconfiguration request to the radio terminal 40. The radio terminal 40 receives the RRC reconfiguration request.

In step S108, the LTE base station 10-2 transmits an eNB status notification to the MME/SGW 20 by using the S1 interface. The MME/SGW 20 receives the eNB status notification.

In step S109, the MME/SGW 20 transmits an MME status notification to the LTE base station 10-1 by using the S1 interface. The LTE base station 10-1 receives the MME status notification.

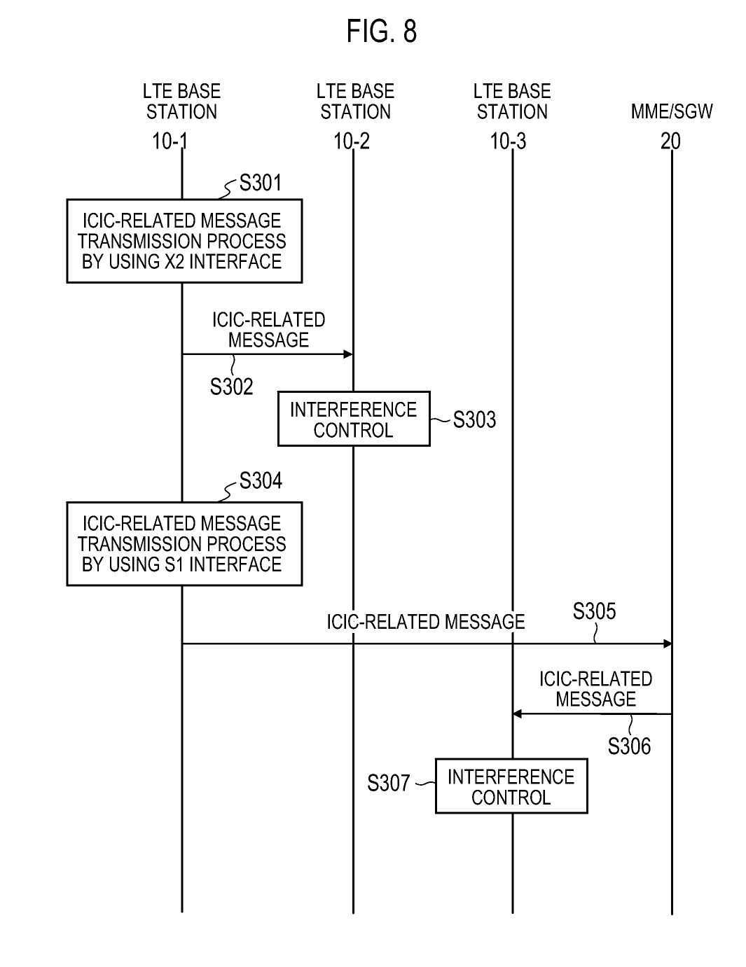

FIG. 8 is a sequence diagram showing an operation of transmitting and receiving an ICIC-related message in the radio communication system 1. FIG. 8 is an example when an interference occurs in the LTE base station 10-1. Furthermore, FIG. 8 is an example of a case when the X2 interface (the X2 interface #1 in FIG. 4) between the LTE base station 10-1 and the LTE base station 10-2 is utilized, and the X2 interface (the X2 interface #2 in FIG. 4) between the LTE base station 10-1 and the LTE base station 10-2 is not utilized.

In step S301, the LTE base station 10-1 performs the process of transmitting an ICIC-related message by using the X2 interface. Specifically, the following process is performed.

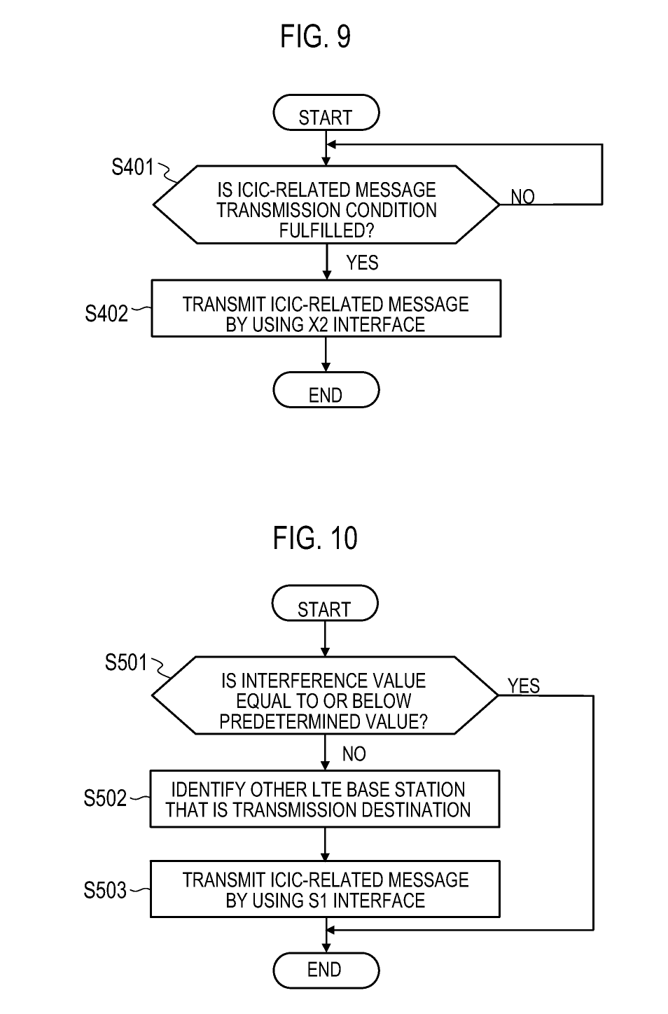

FIG. 9 is a flowchart showing an operation during the transmission of an ICIC-related message by using the X2 interface in the LTE base station 10-1.

In step S401, the LTE base station 10-1 determines whether or not the transmission condition of an ICIC-related message is fulfilled. When the transmission condition of the ICIC-related message is fulfilled, then in step S402, the LTE base station 10-1 transmits the ICIC-related message to the LTE base station 10-2 by using the X2 interface.

Returning to FIG. 8, the explanation continues. In step S302, the ICIC-related message is transmitted from the LTE base station 10-1 to the LTE base station 10-2 by using the X2 interface.

In step S303, the LTE base station 10-2 performs interference control in accordance with the received ICIC-related message.

Following this, in step S304, the LTE base station 10-1 performs the process of transmitting the ICIC-related message by using the S1 interface.

Specifically, the following process is performed.

FIG. 10 is a flowchart showing an operation during the transmission of an ICIC-related message in the LTE base station 10-1 by using the S1 interface.

In step S501, the LTE base station 10-1 determines whether or not the value of the interference occurring in the LTE base station 10-1 is equal to or below a predetermined value. When the value of the interference occurring in the LTE base station 10-1 is equal to or below the predetermined value (“YES” in step S501), the series of operations ends. In such a case, the operation in step S305 and thereafter, in FIG. 8, is not performed.

When the value of the interference occurring in the LTE base station 10-1 exceeds the predetermined value (“NO” in step S501), then in step S502, the LTE base station 10-1 identifies the LTE base station 10-3 that is the transmission destination of the ICIC-related message, by using the S1 interface, on the basis of the stored S1 interface global ID.

In step S503, the LTE base station 10-1 transmits the ICIC-related message to the LTE base station 10-3 by using the S1 interface.

Returning to FIG. 8, the explanation continues. In step S305, the ICIC-related message is transmitted from the LTE base station 10-1 to the LTE base station 10-3 by using the S1 interface.

In step S306, the MME/SGW 20 transmits the received ICIC-related message to the LTE base station 10-3 that is the destination, by using the S1 interface. The LTE base station 10-3 receives the ICIC-related message.

In step S307, the LTE base station 10-3 performs interference control in accordance with the received ICIC-related message.

### (5) Operation and Effect

In the radio communication system 1 according to the embodiment of the present invention, the LTE base station 10-1 transmits an ICIC-related message, to the other LTE base station in which the X2 interface is not utilized between the radio base station the LTE base station 10-1, by using the S1 interface. Therefore, unlike in the past, it is possible to avoid a situation where an ICIC-related message is not transmitted to the other LTE base station in which the X2 interface is not utilized between the LTE base station 10-1, resulting in an appropriate reduction of the interference between the LTE base stations.

Furthermore, first of all, the LTE base station 10-1 transmits an ICIC-related message to the other LTE base station using the X2 interface, and thereafter, if the value of the interference occurring in the LTE base station 10-1 exceeds the predetermined value, in other words, if the interference occurring in the LTE base station 10-1 is not reduced by the interference control in the other LTE base station in which the X2 interface is utilized, the LTE base station 10-1 transmits the ICIC-related message to the other LTE base station by using the S1 interface. Therefore, the use of the S1 interface is reduced to the possible extent while fulfilling the object of reduction in the interference, and the congestion of the core network 30 can be prevented.

(6) Other embodiments

Thus, the present invention has been described with the embodiment. However, it should not be understood that those descriptions and drawings constituting a part of the present disclosure limit the present invention. From this disclosure, a variety of alternate embodiments, examples, and applicable techniques will become apparent to one skilled in the art.

In the aforementioned embodiment, when the ICIC-related message transmission processing unit 154 inside the control unit 102 of the LTE base station 10-1 transmits an ICIC-related message to the MME/SGW 20 by using the S1 interface, the other LTE base station that is the destination is specified to enable the identification of the transfer destination of the ICIC-related message in the MME/SGW 20.

However, the ICIC-related message transmission processing unit 154 may detect the position of the LTE base station 10-1 by using a GPS function and the like, allow information on the detected position (for example, longitude and latitude information) to be included in an ICIC-related message, instead of the information on the other LTE base station serving as a destination, and transmit the ICIC-related message to the MME/SGW 20. In this case, the MME/SGW 20 determines the other LTE base station in a predetermined distance from the LTE base station 10-1 as the transferring destination of the ICIC-related message received from the LTE base station 10-1, on the basis of the position information of the LTE base station 10-1 included in the ICIC-related message received from the LTE base station 10-1, and position information of the other LTE base stations held in advance.

Furthermore, in the aforementioned embodiment, the radio communication system 1 employing LTE has been described. However, the present invention can be applied to radio communication systems in the same manner if they are radio communication systems in which a logical transmission path is established between radio base stations.

Thus, it must be understood that the present invention includes various embodiments that are not described herein. Therefore, the present invention is limited only by the specific features of the invention in the scope of the claims reasonably evident from the disclosure above.

In addition, the entire content of Japanese Patent Application No. 2010-093421 (filed on Apr. 14, 2010) is incorporated in the present specification by reference.

### INDUSTRIAL APPLICABILITY

The radio base station and the communication control method according to the present invention can appropriately reduce the interference between radio base stations, and are useful as a radio base station and a communication control method.

1. A radio base station configuring a radio communication system in which a first interface that is a logical transmission path between a radio base station and a network control device in an upper network, and a second interface that is a logical transmission path between radio base stations can be established, comprising:
a transmission unit configured to transmit interference information concerning interference, to a first radio base station in which the second interface is not utilized between the radio base station, by using the first interface.

2. The radio base station according to claim 1, wherein the transmission unit transmits the interference information to the first radio base station by using the first interface, when the connection destination of the radio terminal switches from the first radio base station to the radio base station as a result of the transmission and reception of the control information via the first interface.

3. The radio base station according to claim 1, wherein the transmission unit transmits the interference information, to a second radio base station in which the second interface is utilized between the radio base station, by using the second interface, and thereafter the transmission unit transmits the interference information to the first radio base station, by using the first interface.

4. The radio base station according to claim 3, wherein the transmission unit transmits the interference information, to a second radio base station in which the second interface is utilized between the radio base station, by using the second interface, and thereafter the transmission unit transmits the interference information to the other first radio base station, by using the first interface, if the interference is not reduced.

5. A communication control method in a radio base station configuring a radio communication system in which a first interface that is a logical transmission path between a radio base station and a network control device in an upper network, and a second interface that is a logical transmission path between radio base stations can be established, comprising:
a step of transmitting interference information concerning interference, to a first radio base station in which the second interface is not utilized between the radio base station, by using the first interface.
